(19) United States
(12) Patent Application Publication
(10) Pub. No.: US 2007/0025212 A1
(43) Pub. Date: Feb. 1, 2007

(54) Optical disk apparatus and optical disk reproducing method

(76) Inventors: Yukiyasu Tatsuzawa, Yokohama-shi (JP); Takahiro Nango, Ome-shi (JP); Hideyuki Yamakawa, Kawasaki-shi (JP); Koichi Otake, Yokohama-shi (JP); Toshihiko Kaneshige, Yokohama-shi (JP); Hiroaki Morino, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/493,514

(22) Filed: Jul. 27, 2006

(30) Foreign Application Priority Data
Jul. 27, 2005 (JP) 2005-217772

(51) Int. Cl. G11B 15/52

(52) U.S. Cl. 369/52.1

(57) ABSTRACT

According to one embodiment, there is provided an optical disk apparatus including a detecting unit which reads a reflective light from an optical disk and outputs a read signal, a decoder which decodes the read signal from the detecting unit, an extracting unit which extracts from the read signal the first and second specification information of the same content recorded in first and second areas on the optical disk, a processor which compares the first specification information with the second specification information and processes the specification information based on the comparison result, and a controller which controls the detecting unit or the decoder, based on the specification information processed by the processor.

### CROSS-REFERENCE TO RELATED APPLICATIONS

This application is based upon and claims the benefit of priority from Japanese Patent Application No. 2005-217772, filed Jul. 27, 2005, the entire contents of which are incorporated herein by reference.

### BACKGROUND

1. Field

One embodiment of the invention relates to an optical disk apparatus, and more particularly to an optical disk apparatus and an optical disk reproducing method for efficiently decoding the BCA information of double writing format.

2. Description of the Related Art

In the conventional optical disk, for example, a digital versatile disk (DVD), a BCA is arranged in an information recording area where the usual data is recorded, in the inner radius of the disk. The BCA includes the basic information necessary for reproducing the DVD. In the BCA, the track width and the bit length are large enough to be able to reproduce the information without fine positioning of an optical head.

When a DVD is inserted into a DVD reproducing apparatus, the DVD is rotated at a predetermined speed, laser is emitted from an optical head, the optical head is moved to the radius of the recorded BCA, and the focus servo is applied on the recording layer. Then, information recorded in the BCA is reproduced. The information recorded in the BCA is used for reproducing the usual data.

Patent document 1 (Jpn. Pat. Appln. KOKAI Publication No. 2004-47056) discloses a method of detecting the head of the BCA information in order to read out the BCA information from a DVD at a high precision.

This conventional technique is only to describe the reading method of the conventional BCA information from the DVD and not to describe anything about the method of efficiently reading the BCA information of the double writing format which has been adopted in order to improve reliability in a next-generation high density digital versatile disk (HD DVD).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of the structure of an optical disk apparatus according to one embodiment of the invention;

FIG. 2 is a view for use in describing one example of a BCA handled by the optical disk apparatus according to the embodiment of the invention;

FIG. 3 is a flow chart showing one example of the BCA processing by the optical disk apparatus according to the embodiment of the invention; and

FIG. 4 is a flow chart showing another example of the BCA processing by the optical disk apparatus according to the embodiment of the invention.

### DETAILED DESCRIPTION

Various embodiments according to the invention will be described hereinafter with reference to the accompanying drawings. In general, according to one embodiment of the invention, there is provided an optical disk apparatus comprising: a detecting unit which reads a reflective light from an optical disk and outputs a read signal; a decoder which decodes the read signal from the detecting unit; an extracting unit which extracts, from the read signal, first and second specification information of the same content recorded in first and second areas on the optical disk; a processor which compares the first specification information with the second specification information and processes the specification information based on the comparison result; and a controller which controls the detecting unit or the decoder, based on the specification information processed by the processor.

This is to provide an optical disk apparatus and an optical disk reproducing method for assuredly reproducing and using the specification information (BCA information) by using information in a plurality of areas (BCA) provided in the next generation disk (HD DVD).

One embodiment of the present invention will be hereinafter described in detail with reference to the drawings.

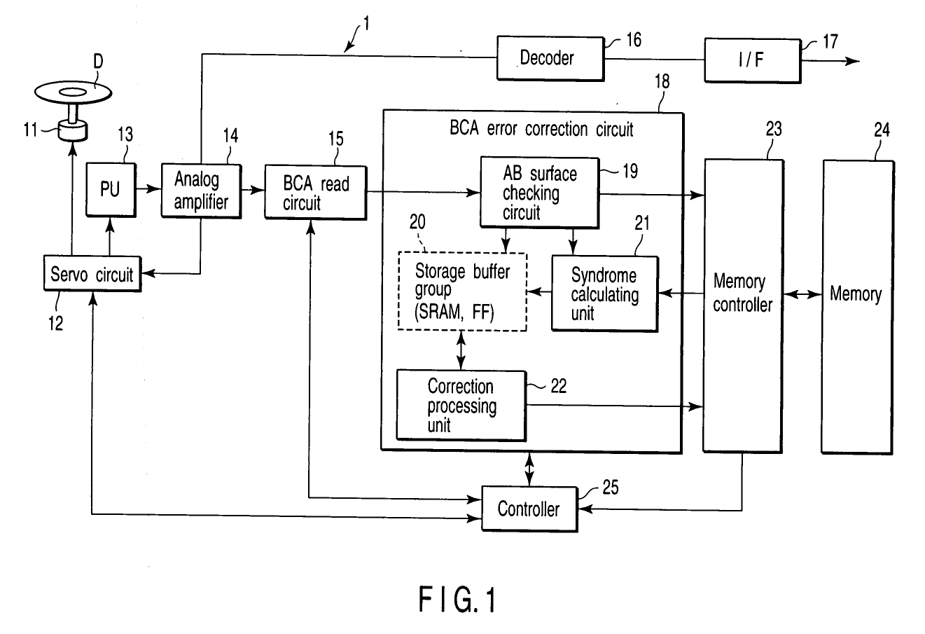

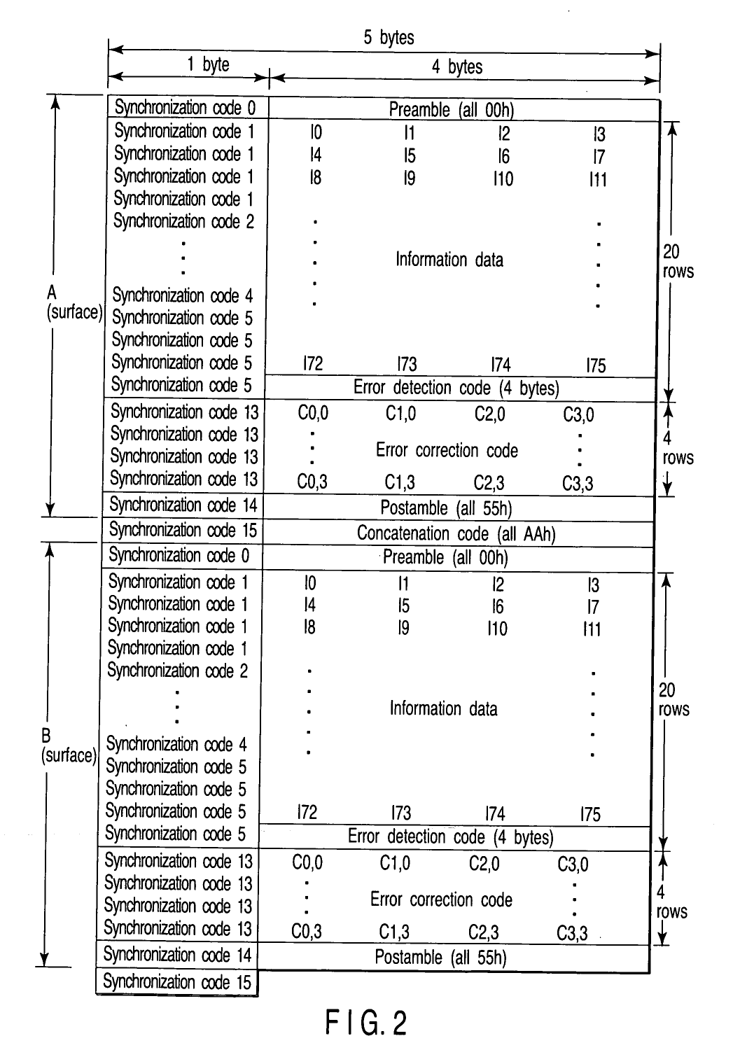

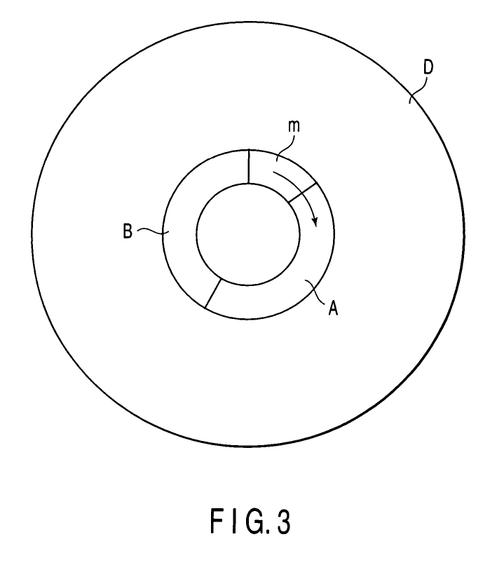

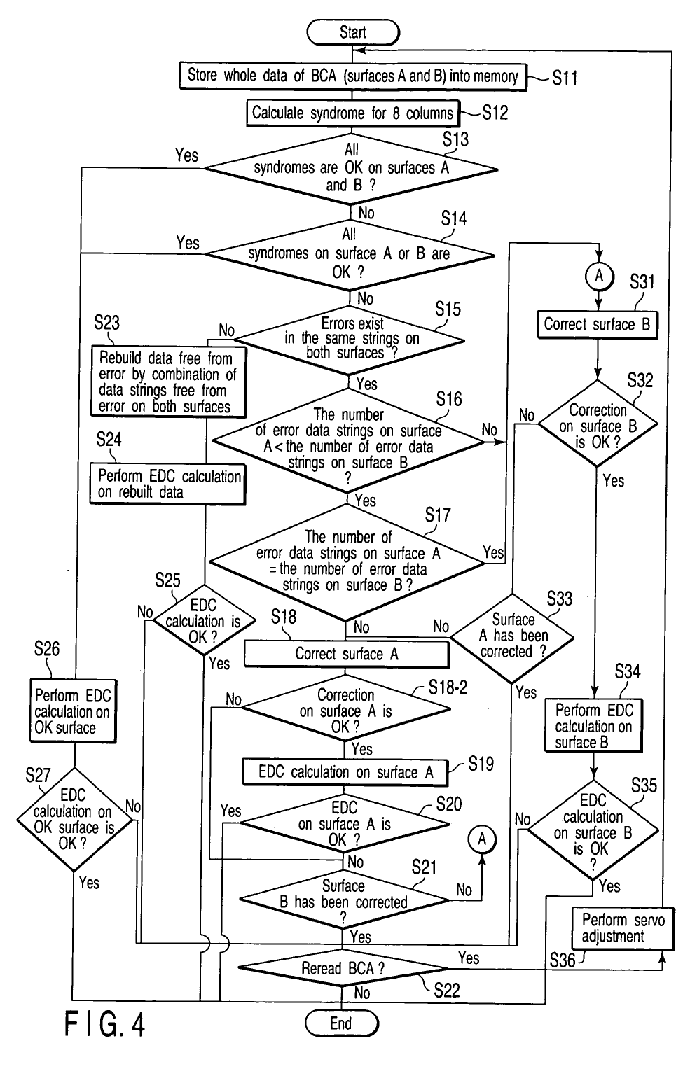

FIG. 1 is a block diagram showing one example of the structure of an optical disk apparatus according to the embodiment of the invention; FIG. 2 is a view for use in describing one example of a BCA handled by the optical disk apparatus according to the embodiment of the invention; FIG. 3 is a flow chart showing one example of the BCA processing by the optical disk apparatus according to the embodiment of the invention; and FIG. 4 is a flow chart showing another example of the BCA processing by the optical disk apparatus according to the embodiment of the invention.

<Optical Disk Apparatus According to One Embodiment of the Invention>

(Structure)

First, the structure of the optical disk apparatus according to the embodiment of the invention will be described in detail using the drawings. In FIG. 1, an optical disk apparatus 1 according to the embodiment comprises a servomotor 11 which rotates an optical disk D at a desired speed, an analog amplifier 14 which reads a reflective light of a laser beam from the optical disk D and amplifies the read signal, a decoder 16 which performs the binary processing and the error correction processing on the amplified signal from the analog amplifier and outputs a reproduction signal, and an I/F 17 which outputs the playback signal from the decoder. The optical disk 1 according to the embodiment of the invention further comprises a BCA read circuit 15 which reads the BCA information upon receipt of the amplified signal from the analog amplifier 14, a BCA error correction circuit 18, a memory controller 23 which receives the output from the circuit 18, a memory 24 connected thereto, and a controller 25 which is connected to each unit in order to control the whole operation.

(Burst Cutting Area (BCA))

A burst cutting area of an HD DVD and the like which the optical disk apparatus 1 according to the embodiment of the invention tries to read will be described in detail with reference to FIGS. 2 and 3.

The data structure of the BCA is formed by two sub data units A and B (it may be referred to as sub data structure) and a concatenation code for concatenating the both, as illustrated in FIG. 2.

In the sub data units A and B, a mirror area m, a first BCA area A, and a second BCA area B are formed on the optical disk D along the arrow indicating the proceeding direction of a laser beam in this order, as illustrated in FIG. 3.

Here, each of the sub data units A and B includes synchronization codes, a preamble, a postamble, an error detecting code, and an error correction code, in addition to the information. The synchronization codes are positioned in every 5 bytes. There are nine kinds of synchronization codes; the synchronization codes 0 to 5 and 13 to 15.

In a bit string of the synchronization codes, the synchronization code 0 is positioned at the head in the sub data unit, and then, the preamble follows it. The contents of the preamble are all 00 (hexadecimal) in each of 4 bytes. The respective synchronization codes 1 to 5 are sequentially positioned in every 16 bytes of the information/the error detecting code.

The information data of the BCA consists of 4 bytes in the horizontal direction and 76 bytes in the vertical direction for 19 lines, and the error detecting code EDC for 4 bytes is attached to the information data (the information data+EDC is referred to as the data unit). This information data is duplicated in order to improve reliability with the concatenation code intervening therebetween. For the sake of explanation, the data is referred to as a block A and a block B with the concatenation code intervening therebetween as illustrated.

When the information to be recorded is smaller than 76 bytes, 00 (hexadecimal) is inserted into all the remaining bytes, and apparently, the information on one sub data unit is fixed at 76 bytes (4 bytes×19 lines). The synchronization codes for the error correction codes are the synchronization codes 13. The synchronization code 14 follows the error correction code and then, the postamble is located. The contents of the postamble are all 55 (hexadecimal) in each of 4 bytes. The last of the sub data unit is the synchronization code 15.

The information in the two sub data units A and B is the same and naturally, the contents of the two sub data units A and B are identical.

The concatenation code for concatenating the two sub data units is of 4 bytes and the contents are all AA (hexadecimal) in every byte. Since the concatenation code is of 4 bytes, the synchronization codes are positioned at every 5 bytes all over the whole data structure.

The contents of the concatenation code have to be different from those of the preamble and the postamble. By selecting AA (hexadecimal) for the concatenation code, the code distance from the contents 55 (hexadecimal) of the postamble becomes maximum, which reduces the risk of error generation. This is why the concatenation code is AA (10101010) as for the postamble 55 (=01010101) and their numerals are mutually inverted between “0” and “1”.

In the embodiment, although the sub data unit is defined as two units A and B, it may be defined as three and more. When the number of the sub data units increases, the volume of the information within one sub data unit decreases accordingly because the size of the BCA is predetermined. Preferably, the number of the sub data units is two.

It is preferable that the sub data unit of the BCA in the optical disk of the invention accords with the data structure of the BCA in a DVD. Therefore, the conventional optical disk for DVD can reproduce one of the several sub data units of the optical disk of the invention.

Although the above description has been made in the case where the contents of the two sub data units are identical, there may be the case where their contents are different. For example, the important information concerned with copy protection may be recorded into the both areas and the information such as disk type may be recorded into one area.

Although the above description has been made using two sub data units as an example, the number of the units may be increased. When the information cannot be stored into one sub data unit, the information may be divided and stored into another sub data unit. For example, four sub data units may be set; two of them may be used as a first set and the remaining two may be used as a second set.

(Operation)

Next, reading processing of the optical disk apparatus's reading the BCA information according to the embodiment of the invention will be hereafter described in detail by using a flow chart of FIG. 4. In the optical disk apparatus 1 according to the invention, stored information is read from the optical disk D by using a pickup unit PU and the read signal is converted by the analog amplifier 14, under control of the controller 25. The BCA read circuit 15 extracts the BCA information on the blocks A and B from this converted signal.

All the extracted BCA data on the blocks A and B is stored into the memory 24 through the memory controller 23 under control of the controller 25 (Step S11). A syndrome calculating unit 21 calculates a syndrome for 8 columns in total of the blocks A and B (Step S12).

Here, whether the syndrome is OK or not is checked on the blocks A and B (Step S13). When it is OK, EDC calculation is performed on the block where it is OK (Step S26). When the EDC calculation results in OK (Step S27), the controller 25 judges it as the normal BCA information, extracts the disk type, the physical specification information and the like from the BCA information, and performs the processing of the pickup unit PU 13 and the decoder 16 based on this information.

Further, in Step S13, when not all the syndromes on the blocks A and B are OK, whether the syndrome on at least one of the blocks A and B is OK is checked (Step S14). When it is OK, the processing of Step S26 and later will be performed similarly.

When all the syndromes on the both blocks A and B are not OK, whether errors exist in the same data strings on the both blocks is checked (Step S15). When there are no such errors, each data string free from error on each block is combined together and the data free from error is rebuilt (Step S23). Thereafter, EDC calculation is performed on the rebuilt data (Step S24). When the EDC calculation results in OK (Step S25), the controller 25 judges it as the normal BCA information, extracts the specification information such as the disk type and the like from the BCA information, and performs the processing of the pickup unit 13 and the decoder 16 based on this information.

Namely, when errors exist on the both correction blocks (block A and block B) and the positions of the error data strings on the both blocks are different from each other (judged by the value of syndrome), data is rebuilt by combination of the information on the data strings free from errors on the both blocks, thereby omitting the correction processing.

In Step S15, when errors do not exist in the same strings on the both blocks, whether the number of the error data strings on the block A <the number of the error data strings on the block B is checked (Step S16), further, whether the number of the error data strings on the block A=the number of the error data strings on the block B is checked (Step S17). When the number of the error data strings on the block A is more than that on the block B, the correction processing is performed on the block B. When the number of the error data strings on the block A is not more than that on the block B but equal to that on the block B, the correction processing is performed on the block B (Step S31).

An AB block checking circuit 19 for checking the blocks A and B is used to recognize the blocks A and B, and when the number of the error data strings on the block A is equal to that on the block B, the correction processing starts from the block B having less influence of direct current fluctuation. As illustrated in FIG. 3, the mirror area m, the block A of the BCA, and the block B of the BCA are aligned in the order of the proceeding direction of a laser beam and the direct current fluctuation affects the BCA on the block A much more because it is immediately after the mirror area m. Relatively, the BCA on the block B is not so much affected by the direct current fluctuation because it is after the block A. Therefore, the processing time and the power consumption can be reduced when the correction processing starts from the block B of smaller direct current fluctuation.

•AB Block Checking Circuit 19

The operation of the AB block checking circuit 19 will be described here. The AB block checking circuit 19 shown in FIG. 1 receives the BCA information from the BCA read circuit 15 and checks it as follows.

In a check using the concatenation code, when the postamble (55h) is detected before the concatenation code arrives (AAh), it is the block A, and when the postamble (55h) is detected after the concatenation code arrives (AAh), it is the block B.

In a method of detecting the mirror area m for a check, the mirror area of the BCA exists in the BCA of the HD DVD and when data arrives after detecting the mirror area m, the data is judged to be of the block A.

When the number of the error data strings on the block A is not more than the number of the error data strings on the block B in the former Step S16, and when the number of the error data strings on the block A is not equal to that on the block B (namely, when the number of the error data strings on the block A is less than that on the block B), the error correction processing on the block A is performed (Step S18). When the correction processing on the block A results in OK (Step S18-2), the EDC calculation is performed on the block A (Step S19). In this state, when the EDC on the block A results in OK (Step S20), it is judged to be the normal BCA information, the specification information such as the disk type and the like is extracted from the BCA information, and the processing of the pickup unit PU 13 and the decoder 16 is performed based on this information. When there is some problem in the correction processing on the block A in Step S18-2, the processing skips to Step S21, in which whether the block B should be corrected or not is checked.

When the EDC does not result in OK (Step S20), whether or not the correction processing has been performed on the block B previously is checked (Step S21), and when the block B has not been corrected, the processing skips to Step S31, where the correction processing is performed on the block B. When the block B has been corrected previously, whether the BCA is reread or not is checked (Step S22), when it is not reread, a display such as non-readable is performed (not necessarily performed), and the processing is finished. When the BCA is reread, the processing skips to Step S11, where the processing is repeated, after the servo adjustment is performed (Step S36). The servo adjustment in the case of rereading means the switching of the servo state such as tilt adjustment, focus adjustment of the servo, re-seek, and changing the rotation speed of the optical disk.

In Step S31, after the error correction is performed on the block B, whether the result of the correction on the block B is OK is checked (Step S32), and when it is not OK, whether the block A has been corrected previously or not is checked (Step S33). When the block A has not been corrected, the processing skips to Step S18, where the processing of the block A correction and the later is performed. When the block A has been corrected, whether the rereading processing of the BCA is performed or not is checked (Step S22).

When the result of the correction on the block B is OK in Step S32, whether the EDC calculation on the block B is OK or not is checked (Step S34). When the EDC calculation on the block B is not OK (Step S35), whether the rereading processing of the BCA is performed or not is checked (Step S22). When the EDC calculation on the block B is OK, it is judged to be the normal BCA information, the specification information such as the disk type and the like is extracted from the BCA information, and the processing of the pickup unit PU 13 and the decoder 16 is performed based on this information.

As specifically described above by using the drawings, according to the optical disk concerned with the invention, it is possible to improve stability in the operation by efficiently performing the correction processing by full use of the double written BCA information.

More specifically, when errors exist on the both correction blocks (hereinafter, referred to as the block A and the block B) and when the positions of the error data strings on the both blocks are different from each other (judged by the value of the syndrome), data is rebuilt by combination of the information in the data strings free from errors on the both blocks, which can omit the correction processing, hence to reduce the processing time and the power consumption.

Further, the number of the error data strings on one block is compared with that on the other block, and the correction processing starts from the block having less error data strings, thereby reducing the processing time and the power consumption.

Further, there is provided the AB block checking circuit for checking the block A or B, and when the number of the error data strings on the block A is equal to that on the block B, the correction processing starts from the block B having less influence of the direct current fluctuation, thereby reducing the processing time and the power consumption.

According to the above embodiment, those skilled in the art can realize the invention, and various modifications and variations can be made easily by those skilled in the art and it can be applied to various embodiments but for the inventive ability. Therefore, this invention is intended to cover a wide range as far as it does not contradict the disclosed principle and novel features and it is not restricted to the above-mentioned embodiment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk apparatus comprising:
a detecting unit which reads a reflective light from an optical disk and outputs a read signal;
a decoder which decodes the read signal from the detecting unit;
an extracting unit which extracts, from the read signal, first and second specification information of the same content recorded in first and second areas on the optical disk;
a processor which compares the first specification information with the second specification information and processes the specification information based on the comparison result; and
a controller which controls the detecting unit or the decoder, based on the specification information processed by the processor.

2. The optical disk apparatus according to claim 1, wherein the processor checks the presence of an error as for each data string in the first and the second specification information and combines the data strings free from errors in the first specification information with the data strings free from errors in the second specification information.

3. The optical disk apparatus according to claim 1, wherein the processor checks the presence of an error as for each data string in the first and the second specification information, selects the specification information having the less error data strings from the first specification information and the second specification information, and corrects the errors.

4. The optical disk apparatus according to claim 1, wherein a mirror area, the first area, and the second area are aligned on the optical disk in the order of a proceeding direction of a laser beam which the detecting unit irradiates, and
the processor checks the presence of an error as for each data string in the first and the second specification information, and when it is judged that errors exist in both the first and the second specification information, corrects the errors of the data strings in the second specification information.

5. An optical disk reproducing method comprising:
a step of reading a reflective light from an optical disk and outputting a read signal;
a step of extracting, from the read signal, first and second specification information of the same content recorded in first and second areas on the optical disk;
a step of comparing the first specification information with the second specification information and processing the specification information based on the comparison result; and
a step of reproducing the information stored in the optical disk after reading the optical disk and decoding the read signal, based on the processed specification information.

6. The optical disk reproducing method according to claim 5, wherein the presence of an error is checked as for each data string in the first and the second specification information and the data strings free from errors in the first specification information is combined with the data strings free from errors in the second specification information.

7. The optical disk reproducing method according to claim 5, wherein the presence of an error is checked as for each data string in the first and the second specification information, the specification information having the less error data strings is selected from the first specification information and the second specification information, and the errors are corrected.

8. The optical disk reproducing method according to claim 5, wherein a mirror area, the first area, and the second area are aligned on the optical disk in the order of a proceeding direction of a laser beam which is irradiated when reading the reflective light from the optical disk, and
the presence of an error is checked as for each data string in the first and the second specification information, and when it is judged that errors exist in both the first and the second specification information, the errors of the data strings in the second specification information are corrected.
